(19) United States
(12) Patent Application Publication
(10) Pub. No.: US 2021/0081011 A1
(43) Pub. Date: Mar. 18, 2021

(54) CONTROL OF POWER DELIVERY BASED ON TEMPERATURE OF A POWER MODULE

(71) Applicant: FINsix Corporation, Menlo Park, CA (US)

(72) Inventors: Anthony Sagneri, Palo Alto, CA (US); Vanessa Green, San Francisco, CA (US)

(21) Appl. No.: 16/862,907

(22) Filed: Apr. 30, 2020

Related U.S. Application Data
(63) Continuation of application No. 15/916,402, filed on Mar. 9, 2018, now abandoned.
Application No. 15/916,402 is a continuation of application No. PCT/US2016/050911, filed on Sep. 9, 2016.
(60) Provisional application No. 62/216,060, filed on Sep. 9, 2015.

(51) Int. Cl. G06F 1/20; G06F 1/26; G06F 1/28

(52) U.S. Cl. CPC G06F 1/206; Y02D 10/00; G06F 1/28; G06F 1/26

(57) ABSTRACT

A power conversion module, such as a power adapter, provides power delivery capability information to a device powered by the power module. The power delivery capability information is determined based on information indicative of the temperature of the power module.

### CROSS REFERENCE TO RELATED APPLICATIONS

This application is a continuation of U.S. application Ser. No. 15/916,402, filed Mar. 9, 2018, which is a continuation of International PCT Application Serial No. PCT/US2016/050911, filed Sep. 9, 2016 which claims benefit under 35 U.S.C. 119(e) to U.S. Provisional Application Ser. No. 62/216,060, filed Sep. 9, 2015, each of which is hereby incorporated by reference in its entirety.

### DISCUSSION OF RELATED ART

Power adapters are widely used for powering and charging electronics, including consumer electronic devices such as cellular telephones and laptop computers, by way of example. A standard AC/DC power adapter converts the AC line voltage provided by a standard electrical outlet into a DC voltage accepted by an electronic device. A typical AC/DC power adapter for a laptop computer has a brick-shaped power conversion module with the necessary electronics for performing AC/DC power conversion. The power conversion module is attached to one cord with a plug that can be plugged into a standard electrical outlet and another cord with a connector that can be plugged into a laptop computer to power the laptop computer and/or charge its battery. A power adapter can provide voltage regulation, electrical isolation and protection from line surges.

Power adapters for consumer electronic devices tend to be large and heavy. In particular, power adapters for portable electronic devices that draw a larger amount of power (e.g., greater than 40 W), such as laptop computers, for example, are relatively large and heavy. Some power adapters for laptop computers can be more than 20% of the weight of the laptop computer itself. For a mobile device, such as a laptop computer, having a large and heavy power adapter can be particularly cumbersome, as the user may need to carry around such an adapter when the user expects to be away from a power outlet for any significant period of time.

### SUMMARY

Some embodiments relate to a power module, comprising: a housing; an AC/DC converter in the housing, the AC/DC converter being configured to convert an AC input signal into a DC output signal; and a controller configured to control the AC/DC converter, wherein the controller is configured to provide information regarding a power delivery capability of the power module to a device coupled to receive the DC output signal, and to change the information regarding a power delivery capability of the power module based on an indication of a temperature of the power module.

Some embodiments relate to a method of controlling a power module having an AC/DC converter configured to convert an AC input signal into a DC output signal, the method comprising; measuring a parameter of the power module indicative of a temperature of the power module; determining power delivery capability information based on the parameter of the power module indicative of the temperature of the power module; sending the power delivery capability information to a device powered by the power module; and supplying power to the device in accordance with the power delivery capability information.

Some embodiments relate to a method, comprising: receiving power delivery capability information from a power module by a device powered by the power module; determining a power delivery capability based on the power delivery capability information; receiving power from the power module in accordance with the determined power delivery capability; and displaying an indication of the determined power delivery capability.

Some embodiments relate to device comprising a controller configured to: receive power delivery capability information from a power module by a device powered by the power module; determine a power delivery capability based on the power delivery capability information; receive power from the power module in accordance with the determined power delivery capability; and display an indication of the determined power delivery capability.

Some embodiments relate to a power module, comprising: a power converter; and a controller configured to control the power converter, wherein the controller is configured to provide information regarding a power delivery capability of the power module to a device coupled to receive the DC output signal, and to change the information regarding a power delivery capability of the power module based on an indication of a temperature of the power module.

Some embodiments relate to a method of controlling a power module, the method comprising; measuring a parameter of the power module indicative of a temperature of the power module; determining power delivery capability information based on the parameter of the power module indicative of the temperature of the power module; sending the power delivery capability information to a device powered by the power module; and supplying power to the device in accordance with the power delivery capability information.

The power module may comprise a power adapter.

The power module may further comprise a temperature sensor to sense the temperature of the power module and generate a signal with the indication of the temperature of the power module.

The power module may comprise a Universal Serial Bus port to provide the DC output signal.

The power module may be configured to communicate with the device in accordance with a Universal Serial Bus Power Delivery Specification.

The controller may be configured to provide information to the device indicating a reduced power delivery capability of the power module in response to a rise in the temperature of the power module.

The power module may be configured to negotiate reduced power delivery with the device in response to a rise in the temperature of the power module above a threshold.

The power module may comprise at least one compartment in the housing, the at least one compartment comprising a phase change material having a transition temperature between 25° C. and 85° C., optionally between 30° C. and 50° C.

The power module may further comprise a second material having a thermal conductivity higher than that of the phase change material, the second material being between first and second regions of the phase change material.

The second material may comprise a metal.

The power module may have a volume no greater than 4 cubic inches.

The phase change material may be of a volume and configuration such that a temperature of an exterior surface of the housing remains below a temperature of 40° C. when the power module delivers an average power of at least 45 W for a period of 30 minutes.

The phase change material may be of a volume and configuration such that a temperature of the exterior surface of the housing remains below a temperature of 40° C. when the power module delivers an average power of at least 45 W for a period of 2 hours.

The power delivery capability of the power module may comprise at least one of a power, current and/or voltage.

The power module may be configured to determine the indication of the temperature of the power module by measuring energy through the power module over time.

The measuring of the parameter may be performed using a temperature sensor.

The parameter may comprise an amount of energy processed by the power module over time.

When the parameter indicates an increase in temperature of the power module over a threshold, the power delivery capability information may be changed to indicate a reduced power delivery capability.

The method may further include receiving a selected power delivery capability from the device.

The power module may be controlled based on the selected power delivery capability.

Some embodiments relate to a non-transitory computer readable storage medium having stored thereon instructions, which, when executed, perform any method described herein.

The foregoing summary is provided by way of illustration, and is not intended to be limiting.

### BRIEF DESCRIPTION OF DRAWINGS

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques described herein.

FIG. 1 shows a power adapter having an active heat removal system, according to some embodiments.

FIG. 2 shows a cross-sectional view of the power adapter of FIG. 1.

FIG. 3 shows a cutaway side view of the power adapter of FIG. 1.

FIG. 4A shows a cross-sectional view of a power adapter of FIG. 4B having a passive heat removal system with a plurality of enclosures.

FIG. 4B shows a perspective view of a power adapter having a passive heat removal system with a plurality of enclosures.

FIG. 5A shows a cross-sectional view of a power adapter of FIG. 5B having a passive heat removal system with thermally insulating caps.

FIG. 5B shows a side view of a power adapter having a passive heat removal system with thermally insulating caps.

FIG. 6A shows a cutaway side view of a power adapter having a passive heat removal system with regions of high thermal mass.

FIG. 6B shows a cross-sectional view of the power adapter of FIG. 6A along the line B-B′.

FIG. 6C shows a cross-sectional view of the power adapter of FIG. 6A along the line C-C′.

FIG. 7A shows a cutaway side view of a power adapter having a passive heat removal system with regions of high thermal conductivity and regions of high thermal mass.

FIG. 7B shows a cross-sectional view of the power adapter of FIG. 7A.

FIG. 8 shows a block diagram illustrating power and control circuitry 206, as well as optional sensors and an indicator device.

FIG. 9A illustrates the exchange of information between a power module and a powered device regarding selection of a power level.

FIG. 9B illustrates display of an indication to a user of the level of power being provided to a device.

FIG. 10 shows a flowchart of a method of determining a power delivery level.

FIG. 11 shows a power adapter having a plurality of DC output connection ports.

### DETAILED DESCRIPTION

Some embodiments relate to power conversion modules, such as power adapters, having AC/DC converters that are designed to convert a standard AC mains voltage into a DC voltage to provide power to an electronic device.

As mentioned above, power adapters for portable electronic devices that consume a substantial amount of power (e.g., greater than 40 W), such as laptop computers, for example, tend to be large and bulky. The present inventors have appreciated that there are two key limitations, either of which may prevent reducing the size of such a power adapter.

One limitation is the minimum size of the passive components (e.g., inductors and capacitors) used for power conversion. If the power conversion electronics utilizes a switched mode power converter that switches at typical power converter switching frequencies, the passive components needed for such a power converter may need to be prohibitively large to provide a sufficient amount of amount of energy storage during the switching intervals. When such a limitation applies, the size of the power adapter cannot be reduced, as the ability to reduce the size of the power adapter is limited by the size of the passive components.

Using a high frequency switching power converter can allow reducing the size of the passive components, thereby allowing the size of the power adapter to be reduced. However, when a high frequency switching power converter is used, the ability to reduce the size of the power adapter is no longer limited by the size of the passive components, but by the capability of removing heat from the power adapter. Power conversion circuitry, no matter how well designed to maximize efficiency, is less than 100% efficient, and the power that is lost is converted into heat. The smaller a power adapter is made, the more challenging it becomes to remove the heat that is produced by its power conversion electronics. Failing to remove the heat adequately can cause a rise in temperature that may reduce component lifetimes and/or cause the temperature of the power adapter to exceed acceptable standards for consumer electronic devices. For example, a power adapter with a plastic housing designed for consumer electronics applications may be required to maintain an outside surface temperature of less than 85° C. to meet IEC and UL standards. Standard power adapters are not designed to remove a significant amount of heat produced in a small volume.

In accordance with some embodiments, techniques are described herein that enable forming power adapters of relatively small size that are capable of providing a significant amount of power to one or more electronic devices. The techniques described herein enable reliably removing heat from a power converter of small size. Heat removal systems are described including active heat removal systems, passive heat removal systems and hybrid heat removal systems.

In some embodiments, a power adapter includes an actuated heat removal device, such as a fan, for example, that removes heat produced by the power adapter to enable keeping the temperature of the power adapter within an acceptable operating range. In some embodiments, one or more openings are provided in the housing of the power adapter to enable the ingress of cooler air from outside the housing and the egress of heated air. Such opening(s) may be provided on more than one side of the housing to provide redundancy in case opening(s) on one or more sides of the power adapter are blocked.

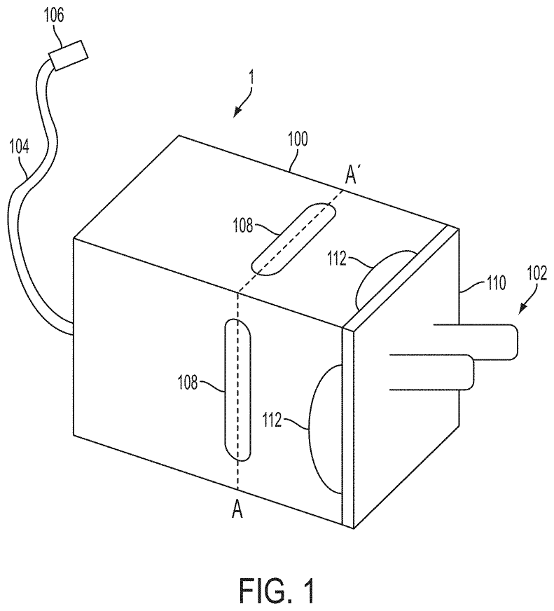

FIG. 1 shows a perspective view of an example of a power adapter 1, according to some embodiments. Power adapter 1 includes a housing 100 which may be formed of plastic or any other suitable material. As shown in FIG. 1, the housing 100 may have substantially a rectangular cuboid shape with a rectangular (e.g., square) cross-section.

In some embodiments, the edges of the housing may be rounded or chamfered. However, the techniques described herein are not limited a rectangular cuboid shape, as housing 100 may have any suitable shape, such as a round shape. Alternatively, in some embodiments, the housing may be substantially flat (e.g., less than a half inch or a quarter inch in height along the vertical direction of FIG. 1).

A plug 102 is provided at one end of the power adapter 1. In the embodiment of FIG. 1, plug 102 is attached to an end cap 110 which may be affixed to the housing 100. Plug 102 may be shaped to plug into a standard electrical outlet. For example, plug 102 may be shaped to plug into a standard U.S. electrical outlet that provides an AC voltage of about 120V RMS. However, the techniques described herein are not limited in this respect, as power adapter 1 may be provided with a plug shaped to plug into any suitable electrical outlet. Further, the techniques described herein are not limited as to a plug 102 being disposed on the end of the power adapter 1, as in some embodiments a cord may be provided that is attached to the end of power adapter 1, and the cord may include a suitable plug.

The power adapter 1 may be connected to a cord 104 to enable connecting the power adapter to an electronic device using connector 106. Connector 106 may have any of a variety of shapes suitable for connecting to a DC power input of a consumer electronic device.

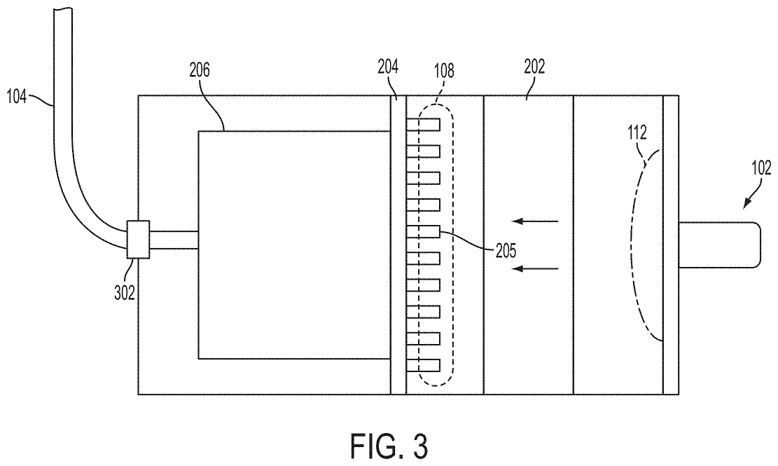

FIG. 1 shows that the housing 100 may include one or more openings 108, 112 for allowing airflow into and/or out of the housing 100. In some embodiments, the power adapter may include an actuated heat removal device 202 (see, e.g., FIG. 3). The actuated heat removal device 202 may be a fan, for example, or another device capable of forcing airflow through the housing 100. If actuated heat removal device 202 includes a fan, any suitable type of fan may be used, such as a piezoelectric fan or an electrostatic fan, for example. In some embodiments, the fan is configured to draw cold air directly over the fan motor, thereby extending the fan's lifespan. Another suitable type of actuated heat removal device used in some embodiments is an electromechanical air pump (e.g., a bellows). An electromechanical air pump may drive puffs of air into and out of the housing. In some embodiments, if an electromechanical air pump is used, a portion of the housing may be operable as an actuatable member to drive the movement of air within the housing. The actuatable member may be a flexible membrane, in some embodiments. The actuatable member may be positioned in any location forming a contiguous space with the plenum.

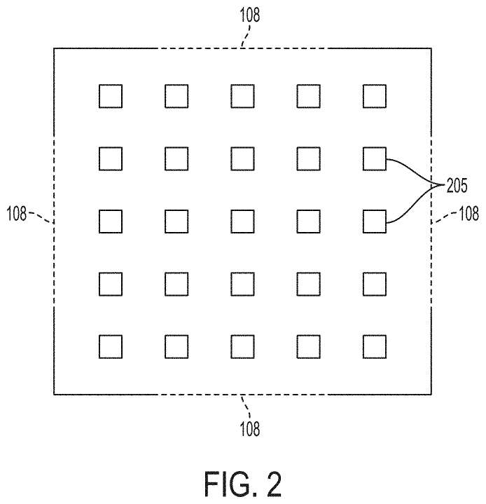

In some embodiments, an actuated heat removal device may drive the flow of air toward or away from the power conversion circuitry of the power adapter 1. As mentioned above, FIG. 1 shows that one or more openings 112 and 108 may be provided on the housing 100 for enabling the flow of air into or out of the housing. In some embodiments, openings 112 may act as inlets to enable the flow of air into the housing 100 and openings 108 may act as outlets to enable the flow of air out of the housing 100. In some embodiments, one or more openings may be provided on each side of the housing 100 disposed along the longitudinal axis of the power adapter 1. In the embodiment of FIG. 1, the housing has four sides disposed along the longitudinal axis of the power adapter, each of which includes an opening 112 (e.g., an inlet) and an opening 108 (e.g., an outlet). FIG. 2 shows a cross section of the power adapter of FIG. 1 along the dashed lines A-A′. As shown in FIG. 2, the power adapter may have four sides along the cross section defined by the dashed lines A-A′.

The inventors have appreciated that one or more sides of the power adapter may rest against one or more object(s) that may obstruct the flow of air through the openings 108 and/or 112, such as a floor, a wall, furniture, a blanket, etc. Accordingly, it may be desirable to provide openings to enable the flow of air through the housing on more than one side of the power adapter in case the flow of air through is obstructed by an object on one or more sides of the power adapter. By providing openings on more than one side of the power adapter, if a first side of the power adapter rests against an air-blocking object, airflow through the housing 100 may be provided through opening(s) on another side of the power adapter. In the embodiments of FIGS. 1-3, openings are provided on four sides of the power adapter, so that even if airflow on three sides of the power adapter is blocked, cooling may be provided by airflow through one or more openings on a fourth side of the power adapter. However the techniques described herein are not limited in this respect, as some embodiments are not limited as to the number of sides of the power adapter on which openings are disposed.

In some embodiments, if airflow through all of the openings in housing 100 is blocked, a controller of the power adapter may control the amount of power delivered by the power adapter to be reduced. The power adapter may include a temperature sensor to sense the internal temperature of the power adapter at the power conversion electronics or another location. When the temperature sensed by the temperature sensor exceeds a threshold, the controller may control the power conversion electronics such that the amount of power delivered at the output is reduced, or the delivery of power is ceased. When the power adapter cools and the temperature of the power adapter reaches a suitable operating point, the controller may control the power conversion electronics such that power delivery is be resumed and/or increased.

FIG. 3 shows a cutaway side view illustrating the interior of the power adapter 1. As shown in FIG. 3, the power adapter 1 includes power and control circuitry 206 which includes power electronics and control circuitry for converting the AC input signal (e.g., received at plug 102) into a DC output signal (e.g., provided via cord 104 to an external electronic device).

In some embodiments, power and control circuitry 206 may be disposed on a heat sink 204. The heat sink 204 may have protrusions 205 that provide a high surface area, enabling the heat produced by power and control circuitry 206 to be dissipated in a plenum within the housing. Protrusions 205 may also produce turbulent airflow within the cavity, thereby facilitating the expulsion of heat from the surface of the heat sink 204. The protrusions 205 of heat sink 204 are also illustrated in FIG. 2.

As discussed above, the actuated heat removal device 202 may be a fan that blows air toward or away from the heat sink 204. In one embodiment, illustrated in FIG. 3, the actuated heat removal device 202 is configured to force air from one or more inlet openings 112 (shown in dashed lines) toward the heat sink 204 and out through one or more outlet openings 108 (also shown in dashed lines). However, the techniques described herein are not limited in this respect, as in some embodiments the actuated heat removal device 202 may be configured to drive airflow in the opposite direction.

In some embodiments, power and control circuitry 206 may be enclosed in an airtight enclosure (and optionally potted). Sealing the power and control circuitry 206 in an airtight enclosure can isolate power and control circuitry 206 from the plenum through which air passes, which can protect the power and control circuitry 206 from foreign substances such as liquid spills, dirt, dust, etc. In the event of failure of a component within the power and control circuitry 206, the use of an airtight enclosure to seal the power and control circuitry 206 can prevent the release of odorous gasses, which can facilitate compliance with FAA regulations, for example.

The actuated heat removal device may be controlled by power and control circuitry 206 through a suitable control connection (not shown) within the housing 100. Similarly, conductors (not shown) may be provided within the housing 100 to provide a connection between the plug 102 and the power and control circuitry 206.

Described above is an embodiment in which one or more openings in the housing 100 are provided on the sides of the power adapter 1. However, the techniques described herein are not limited to providing openings in the housing 100 on the sides of the power adapter 1, as in some embodiments one or more openings may be provided at the end(s) of the adapter. For example, if a plug 102 is included, an opening may be provided between the prongs of the plug to allow air to flow into and/or out of the power adapter 1. In some embodiments, one or more spacers may be included on the end cap 110 to ensure separation between the end cap 110 and the electrical socket, thereby creating a plenum.

In some embodiments, a passive heat removal system may be provided for reliability, cost, and noise considerations. A passive heat removal system may remove heat without the use of an actuated heat removal device.

Existing power adapters have a minimum external surface area set by the power dissipated in the adapter under peak load. The power dissipated Pdiss corresponds to the difference in adapter input power and output power as determined by the adapter efficiency, η, and is equal to: Pdiss=((1−η)/η)*Pout. The magnitude of Pdiss determines the total heat flux to be carried to the adapter's surface to ensure the internal components do not overheat. In turn, the surface area over which the heat flux spreads (the surface area of the adapter system) affects the temperature of the external surface of the housing. When the surface of the housing is directly accessible (e.g., can be contacted by a person or other object), it may be maintained below a safety temperature. For plastic cases the safety temperature may be 85° C.; for metal cases it may be 75° C. In addition to surface area, other factors affect the skin temperature including its emissivity, shape factor, orientation, surrounding ambient, and in the case of an adapter which may be used in a variety of environments, whether it is in contact with another surface (such as a rug, a tabletop, or a sofa cushion). The operating temperature of external surfaces may be kept below the safety temperature, and it may be desirable to keep the temperature of the external surface of the housing even lower, such as lower than 50° C. or lower than 60° C., so that users do not find the device uncomfortable to touch or perceive a malfunction.

The result of the relationship between power dissipated, surface area, skin temperature and certain dimension limits on conventional power electronic components present in a power adapter (such as the main power converter) is to set a minimum volume (e.g., a bounding-box) of the power adapter for a given power adapter efficiency. A power adapter may not be made smaller than the bounding box volume without exceeding the desired external surface temperature. The general industry understanding is that in order for present, passively cooled adapters to be smaller, they need to be made more efficient.

Dramatically reducing the size of the power electronics with respect to power electronics of standard power adapters introduces an additional degree of freedom to the design space. In some embodiments, power electronics having a relatively high switching frequency of 1 MHz or greater may enable reducing the size of the power electronics by as much as a factor of ten, or even greater. In some embodiments, the power electronics may have a switching frequency in the VHF range (30 MHz to 300 MHz), and may utilize resonant switching techniques and/or soft switching techniques to maximize efficiency. An example of suitable power conversion circuitry is described in PCT application WO 2012/024542 (PCT/US2011/048326), which is hereby incorporated by reference in its entirety. Since the size of the power electronics may be reduced dramatically, additional options are made possible for passive heat removal, even at comparable efficiencies to present levels.

As discussed above, the heat generated by the power electronics may need to be dissipated through the bounding surface of the power adapter housing. If efficiency is not increased, the same heat flux may need to be expelled to maintain the internal adapter components at a temperature within their operating limits, and to maintain the outer surface within an acceptable temperature range. In contrast to conventional power adapters, in which nearly all of the space within the power adapter housing may be taken up by the power electronics, power electronics that switches at a high switching frequency may be made much smaller, and may consume a smaller fraction of the volume of the power adapter housing.

In some embodiments, a power adapter housing may have an inner enclosure and an outer enclosure. The inner enclosure enclosing the power electronics may have a higher temperature than that of the outer enclosure. The outer enclosure may have an outer surface that does not exceed a temperature range (e.g., below a safety temperature and/or within a range that is comfortable to the touch). The higher-temperature internal enclosure facilitates the removal of heat from the adapter electronics by convection. Convection is enabled by means of a plenum between inner enclosure and the outer enclosure. The internal enclosure of higher temperature helps to drive stronger convection currents and allow effective heat removal with a smaller total surface area. The external lower-temperature enclosure carries away some heat, but maintains a temperature that may not exceed a temperature range (e.g., below a safety temperature and/or within a range that is comfortable to the touch).

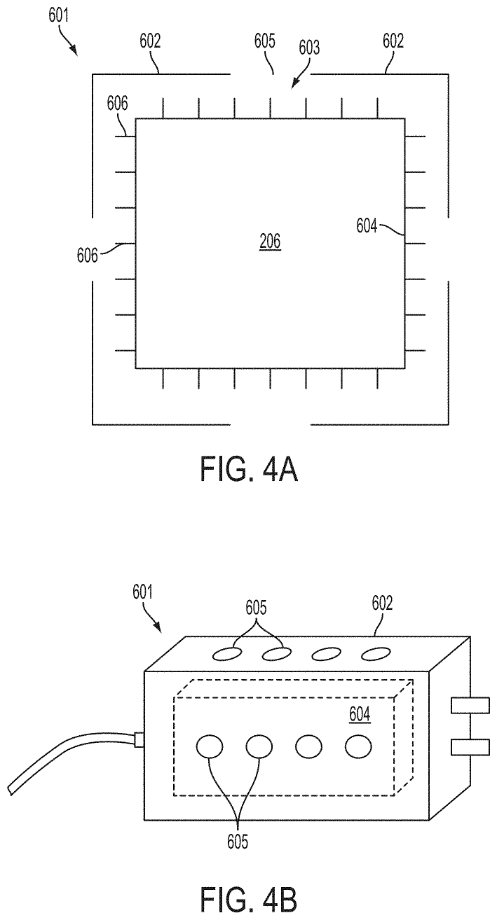

FIG. 4A shows a cross section of a power adapter 601 having an inner enclosure 604 and an outer enclosure 602 separated by a plenum 603, according to some embodiments. FIG. 4B shows a perspective view of the power adapter 601 with inner enclosure 604 shown in dashed lines. As shown in FIG. 4A, power and control circuitry 206 may be enclosed within (e.g., sealed within) inner enclosure 604.

Inner enclosure 604 may have protrusions 606 extending therefrom to increase the surface area of inner enclosure 604 in the plenum 603 and improve convection. Protrusions 606 may include fins, heat pipes, or a combination of fins and heat pipes, or other structures. The air volume between the inner enclosure 604 and the outer enclosure 602 forms the plenum 603 where heat is transferred to convectively-driven air currents that may flow through openings 605 in the outer enclosure 602. Openings 605 may have any suitable shape. The total volume of the power adapter can be made smaller than existing adapters of the same efficiency and power level at least in part because of the increased temperature of the inner enclosure 604 and the smaller power electronics. The peak temperature of the inner enclosure 604 can be limited by the total volume allocated for the plenum 603, the shape and surface area of the protrusions 606, the emissivity of the outer surface of inner enclosure 604, and other factors.

In some embodiments, inner enclosure 604 may have a higher thermal conductivity than outer enclosure 602. The inner enclosure 604 and/or protrusions 606 may be formed of a material with a high thermal conductivity, such as a metal, for example, or any other suitable material. The outer enclosure 602 may be formed of a material with a lower thermal conductivity suitable for a user to touch, such as plastic, for example. The outer enclosure 602 may be formed of a thermally insulating material in order to keep the external touch temperature at an acceptably low level. If so, the convection currents driven through the plenum 603 by the heating of the inner enclosure 604 may carry more of the heat flux from the inner enclosure 604 to the exterior of the power adapter.

The inner enclosure 604 may be sealed, and may protect the adapter electronics from contaminants such as liquids and dirt. If inner enclosure 604 is formed of an electrically conductive material, such as metal, for example, inner enclosure 604 may form a galvanic barrier that prevents electric shock, should the user insert a conductive object into a hole in the outer skin. If inner enclosure 604 is formed of an electrically conductive material, the inner enclosure 604 may provide an effective electromagnetic interference (EMI) barrier.

The inner enclosure 604 may be designed such that convection currents can be supported regardless of the adapter orientation relative to the earth's surface. For instance, a structure having symmetry around the theta and phi axes of a spherical coordinate system can have such a behavior.

The outer enclosure 602 may have a unitary construction, as illustrated in FIGS. 4A and 4B. However, the techniques described herein are not limited in this respect, as outer enclosure 602 may have a non-unitary construction with a plurality of components forming the outer enclosure 602 in a way that can prevent the user from coming in contact with the higher temperature inner enclosure 604.

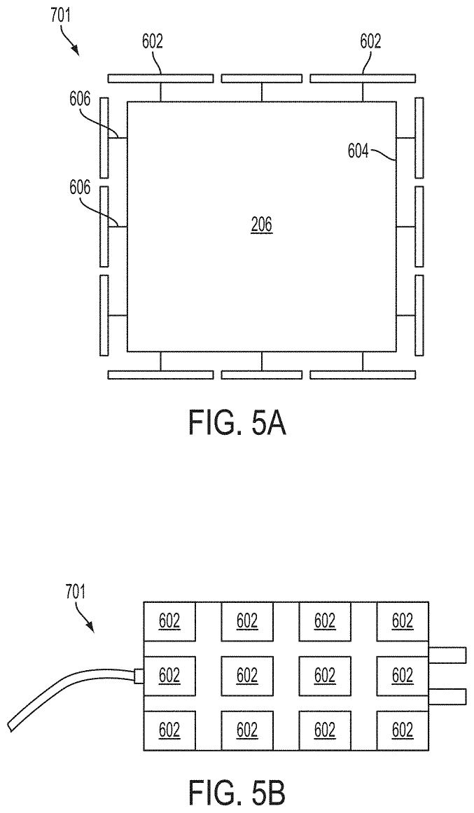

For example, as shown in the cross-sectional view of FIG. 5A and side view of FIG. 5B, the inner enclosure 604 of a power adapter 701 may include a number of protrusions 606 which may be heat-conducting spines. Protrusions 606 may inscribe a parallelepiped or other geometrical volume such as a rectangular cuboid. A thermally insulating cap may tip each of the protrusions 606. Collectively, the thermally insulating caps may form an outer enclosure 602 that prevents the user from direct contact with inner enclosure 604 and/or protrusions 606, and provides a lower touch temperature. The thermally insulating caps need not necessarily contact one another, although optionally may do so. The density of protrusions 606 need not be designed to prevent touch access by the user, as properly sized caps can prevent touch access by the user. The spacing of the protrusions 606 may be adjusted to maximize convective heat transfer and safety. The protrusions 606 may have any suitable shapes such as a cylindrical shape, a fin shape, or may have arbitrarily curved or straight surfaces.

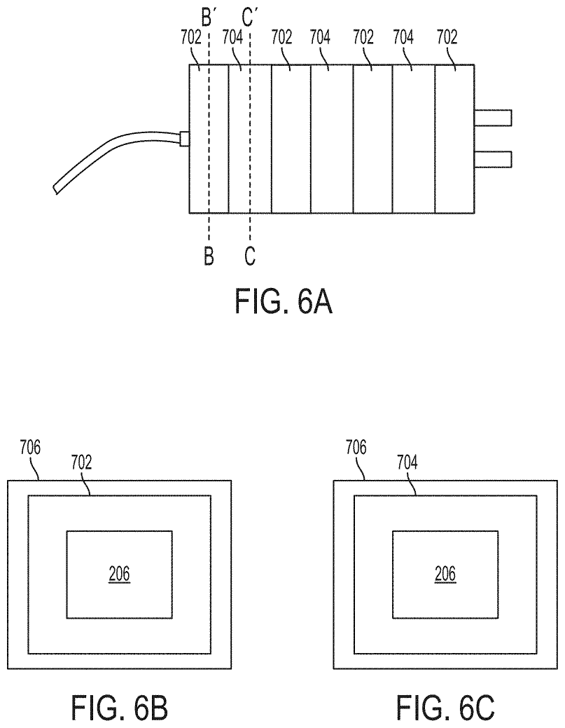

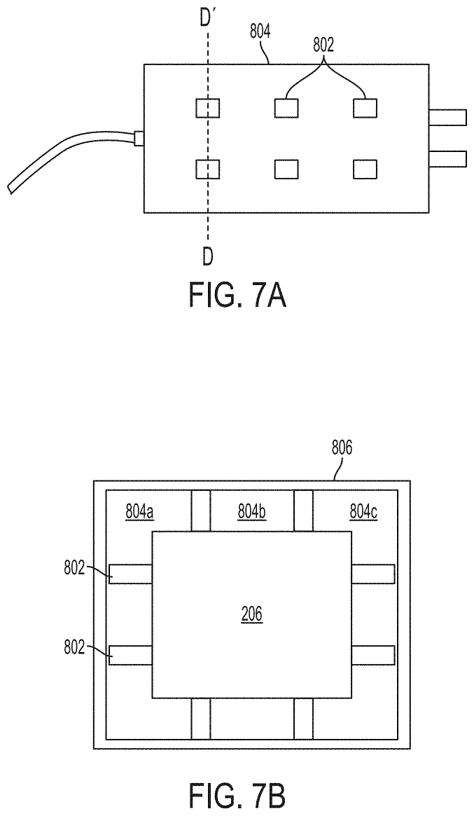

In some embodiments, a power adapter may have a hybrid heat removal system that utilizes passive cooling a portion of the time and used active cooling at other times. For example, a hybrid heat removal system may have an actuated heat removal device that is turned off when it is not needed but is turned on to actively remove heat as needed. For example, the temperature of the power adapter may be sensed and a controller of the power adapter may turn on actuated heat removal device when the temperature exceeds a threshold. In some embodiments, a hybrid heat removal system may avoid a need to increase adapter size to handle worst-case heat loads in a passive heat removal system. In some embodiments, a hybrid heat removal system may be more reliable than an active heat removal system where the cooling actuator runs a larger portion of the time (e.g., continuously). A hybrid heat removal system may enable using a smaller actuated heat removal device than in a purely active heat removal system. A hybrid heat removal system that intermittently operates in an active mode can reduce wear on the moving components, reduce noise, and/or reduce problems such as the collection of dirt or dust. In some embodiments, a hybrid heat removal system may have a housing with a plurality of enclosures, as shown in FIG. 4 or 5, for example, as well as an actuated heat removal device 202 (e.g., as illustrated in FIG. 3). In some embodiments, a hybrid heat removal system may have an actuated heat removal device 202 and a material with a high thermal mass. A passive heat removal system using a material with a high thermal mass will be discussed in connection with FIGS. 6 and 7.

The techniques described herein for controlling heat in a power adapter may be particularly useful in a power adapter having a relatively small volume. As discussed above, such techniques may include actively removing heat from the power adapter using an actuated heat removal device, such as a fan or bellows, to expel heated air from the power adapter housing. Such techniques may include passively removing heat from the power adapter using a housing having an inner enclosure and an outer enclosure having one or more openings. However, has been appreciated that it may be desirable to control heat in a power adapter without the use of openings in the power adapter housing, as such openings may have disadvantages. For example, openings in the power adapter housing may enable the ingress of dirt, dust, or moisture, which may reduce the lifespan of the power adapter. Openings in the power adapter housing may become blocked, thereby reducing heat removal efficiency. Some manufacturers and consumers may prefer a fully enclosed power adapter for reasons of product appearance and/or compliance with safety regulations.

In some embodiments, consideration of the manner in which a power adapter is to be used can allow designing a power adapter that operates with a suitable operating temperature yet which does not require openings in the housing to remove heat. An exemplary use for a power adapter is powering an electronic device, such as a laptop computer. The largest amount of power may be drawn by a laptop when the battery of the laptop is being charged. A typical laptop battery may take about 1.5-2.5 hours to fully charge from an uncharged state. During this time, a significant amount of power (greater than 40 W or 60 W) may be continually provided to the laptop battery via the power adapter. Once the battery reaches approximately 80% charge, the amount of power that is drawn may be reduced. Charging the battery consumes much more power than simply powering the laptop itself. Even if the processor of a laptop computer is running at full utilization, the maximum power draw from the processor may be no more than thermal design power which may be as low as 13 W for ultrabooks, which is far less than the amount of power needed to charge the battery. Thus, in a typical use case where a laptop with a drained battery is plugged into a power adapter, the power adapter will supply a significant amount of power for about 1.5-2.5 hours, then, once the battery is charged, the power demand drops to a lower level.

The present inventors have recognized and appreciated that the heat in a power adapter can be managed by increasing the thermal mass of the power adapter so that the temperature on the exterior surface of the power adapter does not rise above maximum (e.g. 30-40° C.) for the time period of about 1.5-2.5 hours while the power adapter provides power to charge a laptop battery. In the lifecycle of the typical laptop power adapter, the power delivery requirements typically drop at that point, allowing the power adapter time to dissipate the accumulated heat.

In some circumstances, a user may decide to use the power adapter in a way that does not follow the typical usage pattern for power adapter. For example, a user may decide to charge a battery, then remove the battery and charge a second battery immediately thereafter. However such a use case is relatively rare, and can be handled by reducing the amount of power provided by the power adapter in such a circumstance, or designing the power adapter to have an increased thermal mass to account for this scenario.

As discussed above, it is desirable to produce a power adapter having a relatively small volume. However, decreasing the mass of the power adapter conflicts with increasing the thermal mass of the power adapter, as there is less space to accommodate material that can absorb heat.

In some embodiments, a power adapter may include a material with a relatively high thermal mass, or capability of absorbing heat. By including a material with a high thermal mass, the power adapter may have a high ratio of thermal mass to volume. The thermal mass of the power adapter may be increased to a point where the power adapter is capable of charging a laptop battery for 1.5-2.5 hours (e.g., at a power of greater than 40 W or 60 W) without increasing the surface temperature of the power adapter housing above a desired level. In some embodiments, the material with a relatively high thermal mass may be a phase change material that absorbs heat by producing a phase change in the material. For example, a phase change material may change from a solid material to a liquid material at a transition temperature. Phase change materials can be designed that have different transition temperatures. In some embodiments, a phase change material may be selected that has a transition temperature suitable for absorbing heat in a power adapter and limiting the surface temperature of the power adapter to a desired operating range (e.g., below about 30-40° C.). A phase change material may be selected with a transition temperature close to the desired operating range. For example, in some embodiments a phase change material may be selected that has a transition temperature of approximately 30-40° C. However, this is merely by example, and other transition temperatures may be used. A suitable amount of phase change material may be included to prevent the surface of the power adapter from rising above a selected temperature during a time interval, such as the time needed for charging a laptop battery, as discussed above.

In some embodiments, the power adapter may include one or more compartments to contain phase change material. Such compartments may be sealed, to prevent the phase change material from leaking therefrom in a liquid state. In some embodiments, the phase change material may be provided in compartments around the exterior of the power adapter. Since in the solid state phase change material may have a relatively low thermal conductivity, the compartments of phase change material may be arranged in such a way that they can absorb heat generated in the power adapter without unduly blocking the conduction of heat to the surface of the power adapter. In other words, the power adapter may be designed such that the phase change material does not overly block flux of heat from the interior to the exterior of the power adapter. In some embodiments, the power adapter may include a material with a high thermal conductivity to provide a path of high thermal conductivity for heat to flow from the interior of the power adapter to the exterior. Any suitable material with a high thermal conductivity may be used, such as a metal (e.g., aluminum). By providing high-thermal-conductivity paths from the interior to the exterior of the power adapter, heat can be more readily removed from the phase change material. This can reduce the amount of time needed to remove heat from the power adapter. so that the reset time is not overly high.

The phase change material may only absorb a fraction of the heat generated by the adapter. The rest of the heat may leave through the outer surface of the adapter housing. The ratio of absorption to convective removal depends upon the temperature the outer skin is allowed to reach (which is in turn a function of the transition temperature of the phase change material and the ratio of high-thermal-conductivity paths from the power converter to the external surface vs. the paths through the phase change material).

FIG. 6A illustrates a cutaway side view of a power adapter having a relatively high thermal mass, according to some embodiments. FIG. 6B shows a cross section of the power adapter of FIG. 6A along the line B-B′. FIG. 6B shows a cross section of the power adapter of FIG. 6A along the line C-C′. The power adapter of FIGS. 6A-6C includes compartments of phase change material 704 that alternate with regions of high thermal conductivity 702 e.g., metal. The material high thermal conductivity 702 may allow the conduction of heat from the interior to the exterior the power adapter, while the phase change material 704 may provide a high thermal mass and enable absorbing a significant amount of heat. An outer enclosure 706 may be formed around the periphery of the power adapter and may be formed of a material of low thermal conductivity (e.g., plastic) suitable to be touched by a user.

FIG. 7A shows a side view and FIG. 7B shows a cross-sectional view along the line D-D′ of a power adapter according to another embodiment in which compartment(s) of phase change material are distributed around the housing of the power adapter. Regions of high thermal conductivity 802 (e.g., metal) may be formed between the regions of high thermal mass 804 (e.g., which may include phase change material). FIG. 7A illustrates that the regions of high thermal conductivity 802 may be posts extending from the interior to the exterior of the power adapter.

Increasing the thermal mass of the power adapter may enable controlling heat without requiring forming openings in the power adapter housing to allow heated air to be expelled. However, in some embodiments, openings may be included in the housing to facilitate convective heat transfer. In this respect, the technique of increasing the thermal mass of the power adapter may be combined with another passive heat removal concept, such as a housing having inner and outer enclosures. Alternatively or additionally, the technique of increasing the thermal mass of the power adapter may be combined with an active heat removal concept, such as the use of an actuated heat removal device.

In some embodiments, a power adapter may be configured to “quick charge” an electronic device. Using conventional power adapters, it may take 1-3 hours or longer to charge the battery of a consumer electronic device such as a mobile phone, tablet computer, or laptop computer. For example, a conventional power adapter that delivers 15 W may take about an hour to charge the battery of a tablet computer from a fully drained state. It can be desirable to charge mobile devices more quickly, particularly where limited time is available for battery charging. As an example, a traveler may wish to charge the battery of a mobile phone or tablet computer prior to boarding a flight. In some embodiments, a power adapter may provide a higher amount of power to enable charging the battery more quickly. For example, a power adapter may deliver 60 W, which may allow charging a mobile device or tablet computer in a fraction of an hour (e.g., less than fifteen minutes), as compared to taking 1 hour with a power adapter that delivers 15 W.

The present inventors have appreciated that a power adapter designed for “quick charging” may require less capability of absorbing heat than a power adapter designed to charge a laptop battery for a period of hours, as a “quick charging” power adapter may only deliver power for a relatively short time interval (e.g., less than an hour, such as 15-30 minutes or less). A “quick charging” power adapter that includes material with a high thermal mass (e.g., phase change material) may include less such material than a power adapter designed to deliver power for a larger time period. Alternatively or additionally, the heat removal device may operate intermittently (e.g., with a lower duty ratio). In some embodiments, a “quick charging” power adapter may be designed to be smaller than a power adapter designed to deliver power for a longer time period.

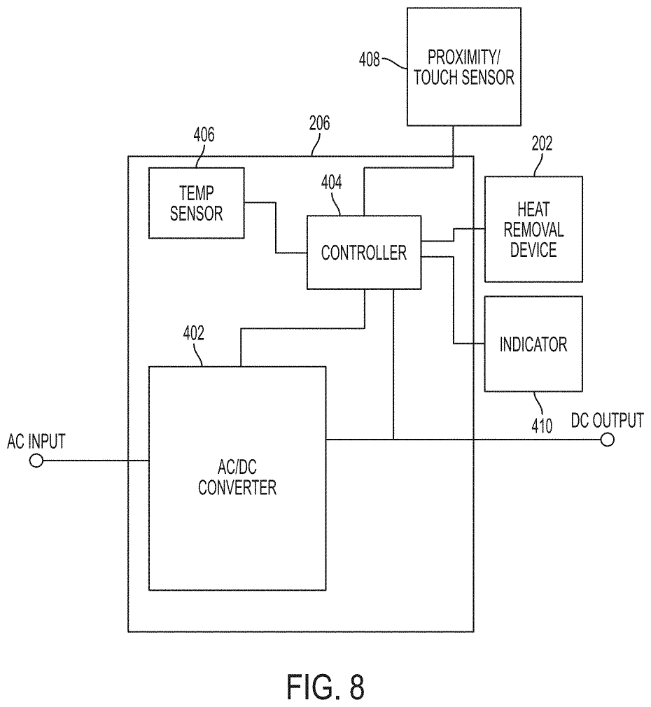

FIG. 8 shows a block diagram illustrating power and control circuitry 206, as well as optional sensors and an indicator device, according to some embodiments. As shown in FIG. 8, power and control circuitry 206 is connected to receive an AC input voltage, such as an AC line voltage. An AC to DC converter 402 is configured to convert the AC input voltage into a DC output voltage. In some embodiments, AC to DC converter 402 may include a rectifier followed by a DC/DC converter. The DC/DC converter may operate at a relatively high switching frequency, such as in the VHF range (30 MHz to 300 MHz), and may utilize resonant switching techniques and/or soft switching techniques to maximize efficiency. Suitable power conversion circuitry is described in PCT application WO 2012/024542 (PCT/US2011/048326), filed Aug. 18, 2011, which is hereby incorporated by reference in its entirety. However, the techniques described herein are not limited in this respect, as other suitable types of AC/DC converters may be used.

Controller 404 may control the operation of AC/DC converter 402 and actuated heat removal device 202 using suitable control signals provided thereto. In some embodiments, as discussed above, controller 404 may receive a signal from temperature sensor 406, and may control the AC/DC converter 402 to reduce the amount of power that is delivered when the temperature exceeds a threshold. In some embodiments, controller 404 may increase or decrease the actuation of actuated heat removal device 202 (e.g., if a fan is used, the speed of the fan may be changed) in response to the temperature signal from temperature sensor 406.

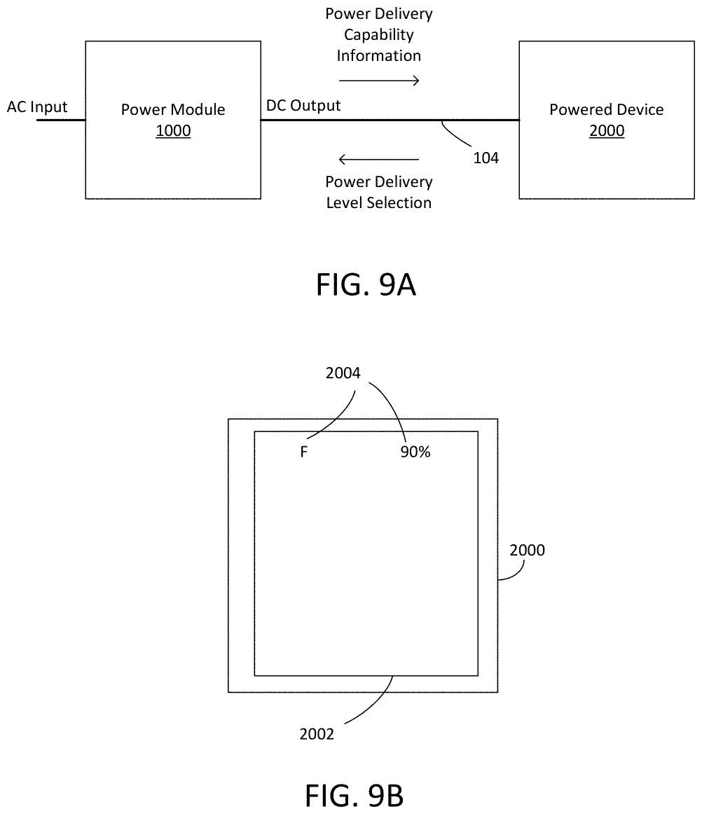

As illustrated in FIG. 9A, in some embodiments, a power module 1000 (e.g., a power adapter) may provide information to the device 2000 to which it provides power regarding a power delivery capability of the power module 1000, such as available level(s) of power, voltage and/or current that can be provided by the power module 1000. As an example of power delivery capability information, the power module 1000 may publish a table of available levels of power, voltage and/or current that it can produce at its DC output connection port. The power module 1000 may communicate with the device 2000 powered by the power module to negotiate a power, voltage and/or current to provide to the device 2000. The device 2000 may receive and review the received power delivery capability information, and then communicate its selection of a suitable level to the power module 1000 by sending power delivery level selection information to the power module 1000. The power module 1000 receives the power delivery level selection information and is then controlled by controller 404 to provide a level of power, voltage and/or current to the device 2000 based on this information.

Any suitable communication bus and/or communication protocol may be used to perform the communication, including a wired or wireless bus, and a wired or wireless communication protocol. For example, in some embodiments, the communication may be performed over a USB (Universal Serial Bus) connection according to the USB Power Delivery Specification. However, this is merely by way of example, as any suitable communication protocol may be used. In some embodiments in which the communication is performed over a wired connection, the communication may be performed over the same wired connection that provides power from the power module 1000 to the device 2000. As discussed above, one example is a USB connection. However, the techniques and devices described herein are not limited to USB connections.

Any suitable device 2000 may be powered by the power module 1000. Some examples of device 2000 include mobile devices having a battery or other energy storage, such as laptop computers, mobile telephones, tablet computers, or wearable devices. However, device 2000 need not be a mobile device, and may be any other type of electronic device, such as a server, gaming console, merely by way of example.

The inventor(s) have recognized and appreciated that although including a phase change material in a power module can be sufficient to limit a rise in temperature of the power module for typical use cases, a user may use the power module in a way that is different from typical use cases. If the power module is used in a way that draws significant power over an extended period of time, the capability of the phase change material to limit the rise in temperature of the power module may be exceeded. For example, although a phase change material may be sufficient to prevent excessive rise in temperature over a cycle of charging the battery of a mobile device (e.g., a laptop), if the user uses the power module to charge several devices in succession, the power module may not have the opportunity to dissipate the heat that is produced, and the temperature of the power module may rise above a desired level.

Regardless of whether a phase change material is included, controller 404 may limit the maximum power, current and/or voltage that can be provided by the power module based upon the temperature of the power module, as sensed by the temperature sensor 406. For example, if the temperature rises above a threshold, the controller 404 may decrease the maximum power, current and/or voltage that can be provided by the power module. Controller 404 may communicate new information regarding the maximum available power, current and/or voltage to the device that it powers via any suitable communication channel, as discussed above. The power module 1000 and device 2000 may communicate to select a reduced power, current and/or voltage level, based on this new information. By reducing the power, current and/or voltage level, a further rise in temperature of the power module can be reduced and/or prevented, and the device may continue to be powered by the power module at a reduced power. When the temperature of the power module is no longer above the threshold, the controller 404 may communicate this information to the device it powers and a higher power, current and/or voltage level may be negotiated and provided by the power module.

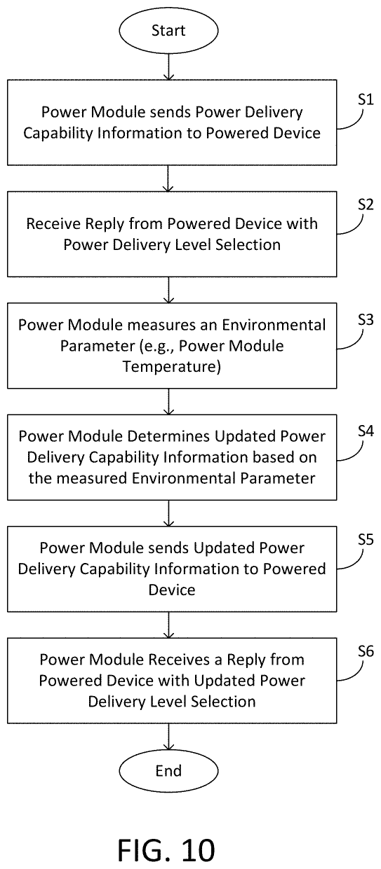

FIG. 10 shows a flowchart illustrating such a technique. In step S1, the power module 1000 may send power delivery capability information to device 2000. Any suitable type of power delivery capability information may be provided, such as a list or table of power, current and/or voltage levels that the power module 1000 can produce. In step S2, the power module 1000 receives a reply from the device 2000 with its selected level of power delivery. Any suitable information may be provided to indicate the selected level of power delivery, such as a selected power, current and/or voltage level, for example.

In step S3, the power module measures an environmental parameter that may impact the level of power the power module 1000 is capable of delivering. For example, the power module may measure the temperature of the power module. The temperature may be measured directly using a temperature sensor, or indirectly using another parameter indicative of temperature, such as an electrical parameter of the power module that varies based on temperature. As an example, the energy through the power module over time may be measured and used to predict the change in temperature of the power module. Such a calculation may be performed by integrating the product of current and voltage at the input or output of the power converter, for example.

In step S4, the power module determines updated power delivery capability information based on the measured environmental parameter. For example, as discussed above, if the temperature increases (e.g., above a threshold) the power module may produce power delivery capability information indicating lower available power level(s). The measured environmental parameter may be mapped to updated power delivery capability information using any suitable mapping. One example of such a mapping is a lookup table or function stored in memory of the power adapter. The mapping may be continuous or step-wise.

As an example of a step-wise mapping, the power adapter may store first and second temperature thresholds T1 and T2, where T2 is higher than T1. When the power module is below temperature T1, the power module may be allowed to charge at a high power level (e.g., a first maximum power level). This may correspond to a “fast charging” mode of operation. Between temperature T1 and T2, the controller may limit the power that can be supplied by the power module to no higher a second maximum power level, which is lower than the first maximum power level. Above temperature T2, the controller may shut down power delivery by the power module. However, this is merely by way of example, as any number of thresholds may be used, with lower maximum power levels being allowed at increasing temperatures. In some embodiments, the maximum power level may be a continuous function of temperature that decreases with increasing temperature.

In step S5, the power module 1000 sends the updated power delivery capability information to the device 2000. In step S6, the power module 1000 may receive a reply from the device 2000 with an updated power delivery selection. In response to receiving this information, the power module 1000 provides an output accordingly.

As illustrated in FIG. 9B, in some embodiments, device 2000 may display an indication 2004 of the amount of power provided to the device 2000. This may allow the user of device 2000 to be informed of the power level being provided to device 2000 by the power module 1000. For example, the device 2000 may have a screen 2002 that displays the indication 2004. Indication 2004 may indicate whether the power module 1000 is able to “fast charge” the device 2000, charge the device 2000 at a normal rate, or charge the device 2000 at a lower rate. Device 2000 may display an icon or letter indicating this information, for example. In an example shown in FIG. 9B, the letter “F” is displayed as indication 2004 to indicate fast charging is being provided. Additionally or alternatively, device 2000 may display a numerical indication of the charging rate, e.g., 1C, 2C. 3C. 4C. etc., or 100%, 50%, 0%, etc., and/or the amount of time needed to fully charge the device 2000 at the current charging level. Providing this information to the user of device 2000 allows the user to be informed as how much time will be necessary to charge device 2000, or the amount of charge that can be expected to be provided in the time available for charging.

For example, a user of device 2000 may be a traveler waiting to catch a flight or another mode of transportation. If the device 2000 is a battery-powered mobile device that has a low state-of-charge, the user may wish to charge device 2000 prior to departure to the extent possible. Accordingly, if the user uses power module 1000 to charge device 2000, device 2000 may indicate information about the charging rate or time to a full charge, for example, so that the user is informed of how much device 2000 will be charged in the time available, and charge device 2000 for additional time if the charging rate is less than desired.

In some embodiments, a power adapter may include a touch or proximity sensor 408 to detect when a person (e.g., a hand, for example) comes close to or touches the power adapter. In response to a signal detected by the touch or proximity sensor 408, a human-perceptible effect may be produced. For example, the power adapter may include an indicator device 410, such as a lighting device (e.g., an LED) to produce light, and/or a device that can produce an audible sound. In response to a signal detected by the touch or proximity sensor 408, the indicator device 410 may be turned on. For example, a lighting device may illuminate, which may assist a user in finding the power adapter in the dark. As another example, an audible sound may be played, which may assist a user in finding an adapter that is in a difficult to reach location (e.g., under or behind furniture, for example). In some embodiments, if an indicator device 410 is included, the power adapter may include an energy storage device such as a battery or ultracapacitor to provide power to the indicator device.

In some embodiments, the controller 404 may be configured to change the actuation of the actuated heat removal device 202 in response to detecting touch or proximity of a person. For example, in some embodiments the actuation of the actuated heat removal device 202 may be reduced or stopped in response to detecting touch or proximity of a human hand.

In some embodiments, controller 404 may measure an amount of power provided to input of the power adapter and/or at the output of the power adapter. The power adapter may have an interface, such as a wired or wireless interface (e.g., a WiFi or Bluetooth interface device) to enable communication with an external device. The power adapter may send information regarding the measured power and/or total energy to the external device (e.g., a laptop computer, tablet computer, smartphone or server) so that a person (e.g., a user) can view the information to find out how much power is consumed by a device connected to the output of the power adapter.

In some embodiments, a power adapter may include one or more DC output connection ports that enable one or more cords to be removably connected thereto. In some embodiments, one or more cords may be provided having electrical connector(s) designed to connect to the DC output connection port(s) of the power adapter. The cord's connector may be held in place at the DC output connection port using any suitable technique, such as a mechanical connection and/or through magnetic attraction.

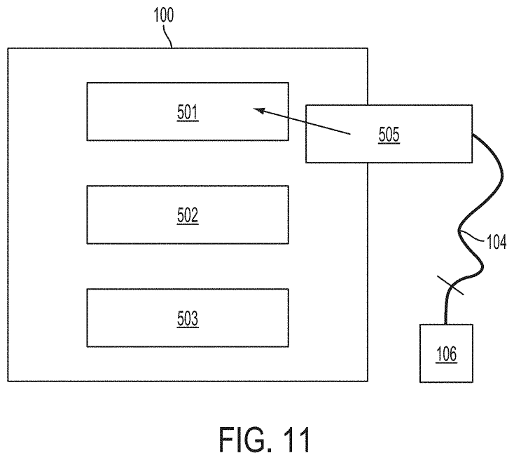

FIG. 11 shows that a power adapter may have a plurality of DC output connection ports 501, 502 and 503. The side of the power adapter shown in FIG. 11 may correspond to the end of the power adapter to which cord 104 is connected (e.g., the left side of FIG. 1, for example). As shown in FIG. 11, cord 104 may have a connector 505 configured to removably connect to DC output connection port 501. Cord 104 may have a connector 106 for connecting to a first type of electronic device (e.g., a laptop). Other cords may be provided having the same type of connector 505 but different connectors 106 for connecting to other types of electronic devices (e.g., smart phones, tablet computers, etc.). Such cords may be provided in a kit along with the power adapter, in some embodiments. Accordingly, a user may select a suitable cord having the appropriate connector 106 to connect to a device that the user wishes to power and/or charge. Advantageously, power adapter may be a universal power adapter that is capable of charging a plurality of different devices (e.g., laptops, cellular telephones, tablet computers, etc.). Accordingly, a user may travel with one small universal power adapter that is capable of charging multiple different devices, rather than carrying multiple power adapters dedicated to each of the user's devices.

In some embodiments, each cord that may be connected to DC output connection port 501 may be individually identifiable by the power adapter when it is plugged in. For example, when a user plugs in a particular type of cord to a DC output connection port, the power adapter may determine the type of cord that is plugged in. Such a determination may be made in any of a variety of ways. For example, the cord may be designed to have a certain impedance when measured, and the power adapter may perform an impedance measurement on a cord when it is connected to identify it. As another example, the cord may be provided with an integrated circuit that identifies the cord. Such an integrated circuit may be provided in connector 505 and/or connector 106, by way of example. As another example, a cord may be identified based on time domain reflectometry. Any suitable technique for identifying a cord may be used.

The power adapter (e.g., controller 404) may determine a suitable DC output voltage to be provided based on identification of the cord. For example, when a first cord is plugged in, the power adapter may identify the cord as being designed to provide a 5V DC output voltage. Accordingly, the controller 404 may control the AC/DC converter 402 to provide a 5V DC output voltage to the corresponding DC output port to which the cord is connected. If another cord is plugged into the same DC output port, the power adapter may identify the cord as being designed to provide a 9V DC output voltage. Accordingly, the controller 404 may control the AC/DC converter 402 to provide a 9V DC output voltage to the DC output port.

In some embodiments, a power adapter is capable of powering and/or charging a plurality of devices at the same time. For example, a first connector of a first cord may plug into DC output connection port 501 for powering a laptop, a second connector of a second cord may plug into a DC output connection port 502 for powering a cellular telephone, and/or a third cord may plug into DC output connection port 503 for powering another device. In a power adapter configured to power and/or charge a plurality of devices at a time, the AC/DC converter may be configured to provide a plurality of DC outputs of suitable output voltages to the respective DC output connection ports. The output voltages of the DC outputs may be different, to enable charging different types of devices, or may be the same.

DC output connection ports 501, 502 and 503 may be the ports of the same shape and type or ports of different shapes and/or types to accept different types of connectors. In some non-limiting embodiments, one or more of the DC output connection ports may be USB ports (e.g., USB 3.0 ports). However, the techniques described herein are not limited as to the particular types of connection port(s) employed.

As discussed above, the power adapters described herein are capable of providing significant output power in a small sized housing. In some embodiments, the volume of the power adapter (excluding cords) may be relatively small, such as 5 cubic inches or less, 4 cubic inches or less, 3 cubic inches or less, or 2 cubic inches or less. For example, in some embodiments the power adapter may be about 2 inches in length or less, about 1 inch in width, or less and about 1 inch in height or less. In some embodiments, the output power provided by the power adapter is at least 30 W, such as at least 40 W, at least 45 W at least 60 W, at least 80 W, or at least 100 W or higher. In some embodiments, the power converter may provide a power conversion density of 15 W/in³ or higher, 20 W/in³ or higher, 30 W/in³ or higher, 40 W/in³ or higher, or 50 W/in³ or higher. The term “power conversion density” refers to the maximum amount of power a power conversion module (e.g., a power adapter) can deliver divided by the volume of the power conversion module (i.e., as bounded by the housing of the power adapter, and excluding cords).

Described above is a power adapter which may be used for powering and/or charging consumer electronic devices. However, the techniques described herein are not limited to power adapters for consumer electronic devices. Some embodiments relate to a power conversion module for other electronic devices, such as servers or other devices in a data center, which may benefit from a reduction in size of the power electronics. Other non-limiting examples of applications include power electronics for industrial equipment and electronics for automobiles, aircraft and ships.

Various aspects of the apparatus and techniques described herein may be used alone, in combination, or in a variety of arrangements not specifically discussed in the embodiments described in the foregoing description and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A power module, comprising:
a housing;
an AC/DC converter in the housing, the AC/DC converter being configured to convert an AC input signal into a DC output signal; and
a controller configured to control the AC/DC converter, wherein the controller is configured to provide information regarding a power delivery capability of the power module to a device coupled to receive the DC output signal, and to change the information regarding the power delivery capability of the power module based on an indication of a temperature of the power module.

2. The power module of claim 1, wherein the power module comprises a power adapter.

3. The power module of claim 1, further comprising a temperature sensor to sense the temperature of the power module and generate a signal with the indication of the temperature of the power module.

4. The power module of claim 1, wherein the power module comprises a Universal Serial Bus port to provide the DC output signal.

5. The power module of claim 4, wherein the power module is configured to communicate with the device in accordance with a Universal Serial Bus Power Delivery Specification.

6. The power module of claim 1, wherein the controller is configured to provide information to the device indicating a reduced power delivery capability of the power module in response to a rise in the temperature of the power module.

7. The power module of claim 6, wherein the power module is configured to negotiate reduced power delivery with the device in response to a rise in the temperature of the power module above a threshold.

8. The power module of claim 1, further comprising at least one compartment in the housing, the at least one compartment comprising a phase change material having a transition temperature between 25° C. and 85° C.

9. The power module of claim 8, further comprising:
a second material having a thermal conductivity higher than that of the phase change material, the second material being between first and second regions of the phase change material.

10. The power module of claim 9, wherein the second material comprises a metal.

11. The power module of claim 8, wherein the phase change material is of a volume and configuration such that a temperature of an exterior surface of the housing remains below a temperature of 40° C. when the power module delivers an average power of at least 45 W for a period of 30 minutes.

12. The power module of claim 8, wherein the phase change material is of a volume and configuration such that a temperature of the exterior surface of the housing remains below a temperature of 40° C. when the power module delivers an average power of at least 45 W for a period of 2 hours.

13. The power module of claim 1, wherein the power module has a volume no greater than 4 cubic inches.

14. The power module of claim 1, wherein the power delivery capability of the power module comprises at least one of a power, current and/or voltage.

15. The power module of claim 1, wherein the power module is configured to determine the indication of the temperature of the power module by measuring energy through the power module over time.

16. A method of controlling a power module having an AC/DC converter configured to convert an AC input signal into a DC output signal, the method comprising;
measuring a parameter of the power module indicative of a temperature of the power module;
determining power delivery capability information based on the parameter of the power module indicative of the temperature of the power module;
sending the power delivery capability information to a device powered by the power module; and
supplying power to the device in accordance with the power delivery capability information.

17. The method of claim 16, wherein the measuring of the parameter is performed using a temperature sensor.

18. The method of claim 16, wherein the parameter comprises an amount of energy processed by the power module over time.

19. (canceled)

20. (canceled)

21. The method of claim 20, wherein the power module is controlled based on the selected power delivery capability.

22. A method, comprising:
receiving power delivery capability information from a power module by a device powered by the power module;
determining a power delivery capability based on the power delivery capability information;
receiving power from the power module in accordance with the determined power delivery capability; and
displaying an indication of the determined power delivery capability.
